(19) United States
(12) Patent Application Publication
(10) Pub. No.: US 2015/0103272 A1
(43) Pub. Date: Apr. 16, 2015

(54) ELECTRIC DEVICE

(71) Applicant: MITSUBISHI ELECTRIC CORPORATION, Tokyo (JP)

(72) Inventor: Takafumi KOKUSHO, Tokyo (JP)

(73) Assignee: MITSUBISHI ELECTRIC CORPORATION, Tokyo (JP)

(21) Appl. No.: 14/501,923

(22) Filed: Sep. 30, 2014

(30) Foreign Application Priority Data
Oct. 16, 2013 (JP) 2013-215525

(51) Int. Cl. G02F 1/1333; G06F 3/042; F21V 8/00

(52) U.S. Cl. CPC G02F 1/13338; G02B 6/0081; G06F 3/0421; G02F 1/133308; G02F 2001/133311; G02F 2001/133331
USPC 349/12

(57) ABSTRACT

An electric device of this disclosure includes: a display device including: a display element configured to display an image; a light source; an intermediate frame configured to hold the light source; and a planar light source device configured to illuminate the display element, and a proximity sensor arranged at an outside of the display device and configured to detect approaching information to the display device. The intermediate frame is provided with an extension part extending outwardly from the display device and a holding part configured to integrally hold the proximity sensor is formed at the extension part.

### CROSS-REFERENCE TO RELATED APPLICATION

This application claims priority from Japanese Patent Application No. 2013-215525 filed on Oct. 16, 2013, the entire subject matter of which is incorporated herein by reference.

### TECHNICAL FIELD

This disclosure relates to an electric device having a display device.

### BACKGROUND

In general, a proximity sensor unit and the like are incorporated in the vicinity of a display device used for an electric device of a vehicle and the like, so that the electric device is configured (for example, refer to JP-A-2007-108842A and WO 2007/105457.

### SUMMARY

In an electric device having a general display device, a frame member configured to hold a proximity sensor unit and the like and a circuit board configured to drive the proximity sensor are required separately from the display device, so that the number of components is increased. Also, since the display device and the member such as the proximity sensor are separately provided, a size of the electric device is increased. Further, in a case where a protection plate is arranged on a front surface of the display device, it is necessary to secure a clearance for incorporating the protection plate into the electric device. Thus, a gap more than need is generated between the protection plate and the frame configuring the electric device, so that a design characteristic is degraded.

Therefore, this disclosure is to suppress an increase in the number of components in an electric device having a display device, a proximity sensor unit and the like, thereby suppressing a size of the electric device from being increased. Further, this disclosure is to suppress degradation of a design characteristic when holding a protection plate.

An electric device of this disclosure includes: a display device including: a display element configured to display an image; a light source; an intermediate frame configured to hold the light source; and a planar light source device configured to illuminate the display element, and a proximity sensor arranged at an outside of the display device and configured to detect approaching information to the display device. The intermediate frame is provided with an extension part extending outwardly from the display device and a holding part configured to integrally hold the proximity sensor is formed at the extension part.

According to the electric device of this disclosure, since the display device and the proximity sensor are integrally held, it is possible to suppress an increase in the number of components, thereby suppressing the size of the electric device from being increased. Also, it is possible to suppress the degradation of the design characteristic when holding the protection plate.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a perspective view of an electric device according to a first illustrative embodiment of this disclosure;

FIG. 2 is an exploded perspective view of the electric device;

FIG. 3 is a front view of the electric device;

FIG. 4 is a sectional view of the electric device taken along a line IV-IV of FIG. 3;

FIG. 5 is a sectional view of the electric device taken along a line V-V of FIG. 3;

FIG. 6 is a rear view of the electric device;

FIG. 7 is a perspective view of an electric device according to a second illustrative embodiment of this disclosure;

FIG. 8 is an exploded perspective view of the electric device;

FIG. 9 is a front view of the electric device;

FIG. 10 is a sectional view of the electric device taken along a line X-X of FIG. 9;

FIG. 11 is a sectional view of the electric device taken along a line XI-XI of FIG. 9;

FIG. 12 is a perspective view of an electric device according to a third illustrative embodiment of this disclosure;

FIG. 13 is an exploded perspective view of the electric device;

FIG. 14 is a front view of the electric device;

FIG. 15 is a sectional view of the electric device taken along a line XV-XV of FIG. 14; and

FIG. 16 is a sectional view of the electric device taken along a line XVI-XVI of FIG. 14.

### DETAILED DESCRIPTION

### First Illustrative Embodiment

### Configuration of Electric Device

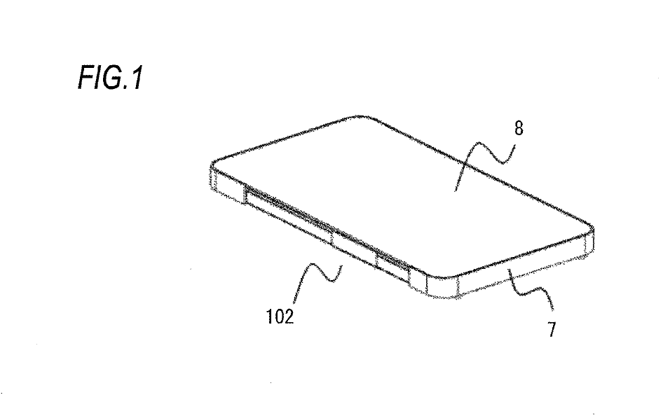

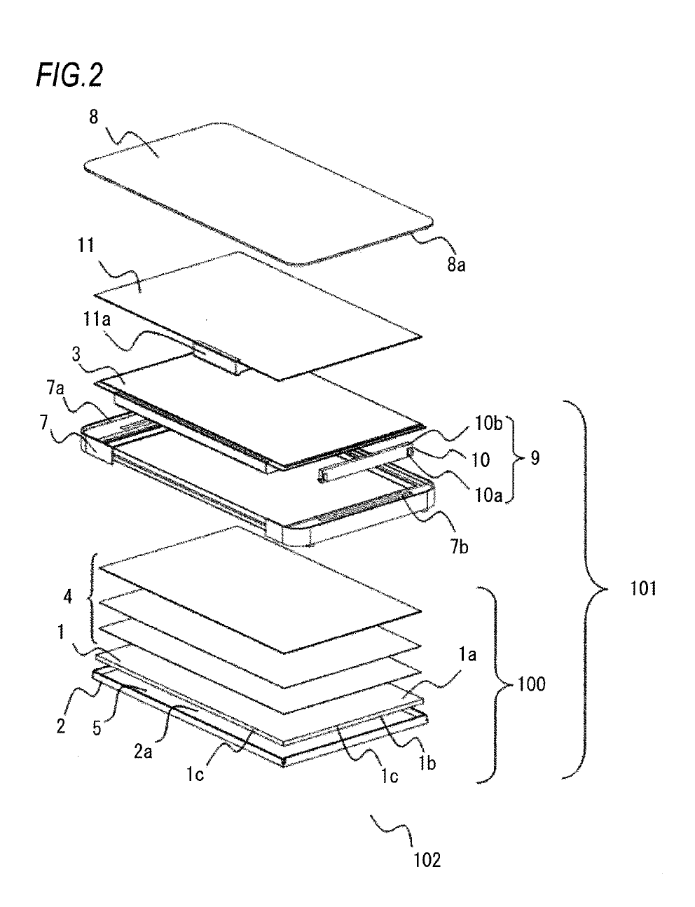

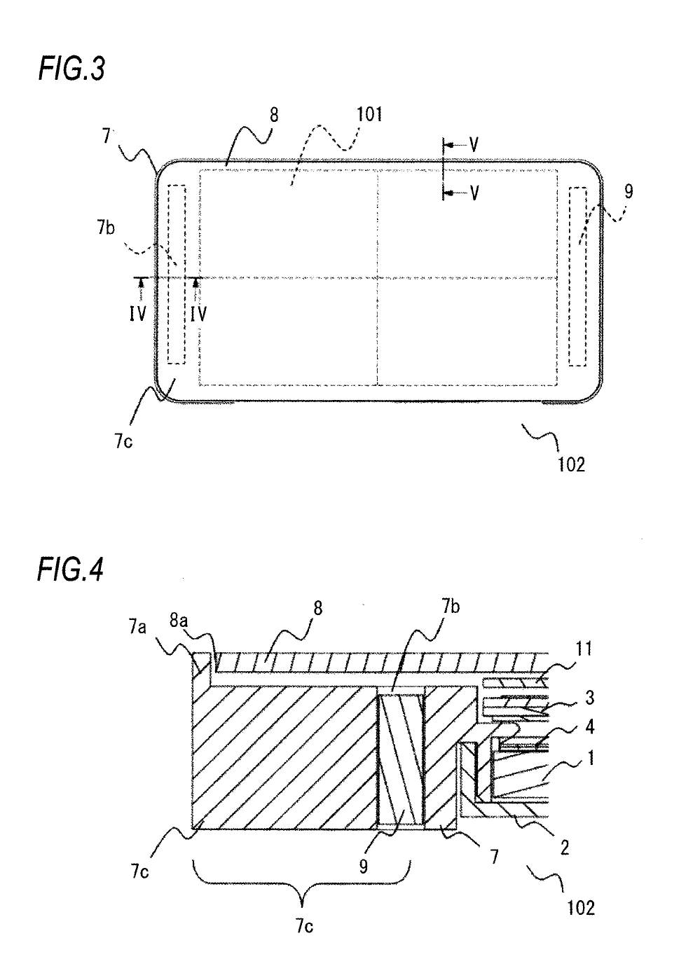

FIG. 1 is a perspective view of an electric device 102 according to a first illustrative embodiment of this disclosure, FIG. 2 is an exploded perspective view of the electric device 102, FIG. 3 is a front view of a planar light source device 100 according to an illustrative embodiment of this disclosure, FIG. 4 is a sectional view taken along a line IV-IV of FIG. 3 and FIG. 5 is a sectional view taken along a line V-V of FIG. 3.

In FIGS. 1 and 2, the electric device 102 has a display device 101. The display device 101 is configured by a display element 3 such as a liquid crystal display panel and a planar light source device 100 configured to illuminate the display element 3. The planar light source device 100 is provided with a light guide plate 1 configured to guide light in a planar shape and to emit the light from a light emission surface 1a. The light guide plate 1 is arranged at a rear frame 2 having an opening 2a. The light guide plate 1 is configured to emit the light in a direction of the opening 2a, which is a light emission direction. The light guide plate 1 has a rectangular flat plate shape, when seen from a plan view, and is provided with the light emission surface 1a, a light emission opposite surface 1b, which is an opposite surface to the light emission surface 1a, and side surfaces 1c substantially perpendicular to the light emission surface 1a and the light emission opposite surface 1b and connecting the light emission surface 1a and the light emission opposite surface 1b. A light source (not shown) configured to emit the light is arranged at the side surface 1c of the light guide plate 1. Also, an optical sheet group 4 including a lens sheet, a diffusion sheet configured to diffuse the light and the like is arranged on the light emission surface 1a of the light guide plate 1. Also, a reflective sheet 5 is arranged on the light emission opposite surface 1b of the light guide plate 1. The light guide plate 1 and the optical sheet group 4 are interposed between the rear frame 2 and an intermediate frame 7 opposed to the rear frame 2, and the display element 3 is held at the intermediate frame 7.

Also, a touch panel 11 is arranged on a front surface of the display element 3 and is optically adhered with the display element 3. In the meantime, only a periphery of the touch panel 11 may be adhered to the intermediate frame 7. Further, a protection plate 8 is arranged on a front surface of the touch panel 11, so that the electric device 102 is configured. Also, an infrared sensor unit 9, which is a proximity sensor configured to detect approaching information to the display device 101, for example, is arranged at a periphery of the display element 3. In the meantime, the infrared sensor unit 9 is provided with an infrared sensor 10a and a light guide plate 10 for an infrared sensor, which is a separate member from the light guide plate for the planar light source device, at a position corresponding to the infrared sensor 10a, and is held by the intermediate frame 7.

<Light Guide Plate>

In the illustrative embodiment, a light guide plate of a flat plate type having a uniform thickness is used as the light guide plate 1. However, the light guide plate 1 having a wedge shape may be also used. The light guide plate 1 is made of a transparent acryl resin, a polycarbonate resin, glass and the like. Also, the light emission opposite surface 1b of the light guide plate 1 is formed with a light scattering part (not shown) configured to scatter a propagation direction of the light and to guide the same in the light emission direction from the light emission surface 1a. The light scattering part functions as a means for reflecting the light towards an interior of the light guide plate 1. As the reflecting means, a method of printing dots on the light emission opposite surface 1b, a method of roughening the light emission opposite surface 1b to form an embossed surface, a method of forming a fine spherical surface or unevenness and the like may be applied.

<Optical Sheets>

The optical sheet group 4 arranged at the light emission surface 1a-side of the light guide plate 1 can be arranged by combining a lens sheet, a diffusion sheet and the like. Also, a structure where the lens sheet is sandwiched between the diffusion sheets may be used. Also, a plurality of lens sheets in which directions of prisms are optimally combined so as to improve the brightness may be used. Further, two or more diffusion sheets may be used so as to improve the diffuseness of the diffusion sheet. Also, only one diffusion sheet may be used or no diffusion sheet may be used. Furthermore, the optical sheet group 4 may include a protection sheet, a viewing angle control sheet and a polarizing reflective sheet. That is, the optical sheet group 4 is combined depending on the desired brightness and light distribution characteristics.

<Reflective Sheet>

The reflective sheet 5 is formed of a material in which barium sulfate or titanium oxide is mixed with polyethylene or polyethylene terephthalate, a material in which a resin is formed with fine air bubbles, a material in which silver is vapor deposited on a metal plate and a material in which paint including titanium oxide is coated on a metal plate. In the meantime, the reflectivity of the reflective sheet 5 is preferably 90% or higher so as to suppress a reflection loss on a reflective surface thereof, and a specular reflection material may be used. The reflective sheet 5 is arranged, so that it is possible to return the light emitted from the light guide plate 1 towards the light guide plate 1, thereby enabling the light to be incident on the light guide plate 1. Therefore, it is possible to improve the utilizing efficiency of the light.

<Display Element>

For the display element 3, a liquid crystal display panel using the birefringence of a liquid crystal material, a display panel having a letter and a picture printed on a transparent plate, and the like may be used. In the liquid crystal display panel, a color filter substrate on which a color filter, a light shield layer, a counter electrode and the like are formed is arranged to face a TFT (Thin Film Transistor) substrate on which a TFT becoming a switching element, a pixel electrode and the like are formed. Also, the liquid crystal display panel includes a space for holding a gap between the two substrates, a seal material for bonding the color filter substrate and the TFT substrate, a liquid crystal material sandwiched between the color filter substrate and the TFT substrate, an orientation film for orienting liquid crystals and a polarization plate. The liquid crystal display panel is configured to control the orientation of the liquid crystal layer through an on and off operation of a voltage by the switching element and to modulate the light incident on the liquid crystal display panel in conformity to an image signal, thereby performing a display operation.

<Touch Panel>

For the touch panel 11, a resistive film type, a projected capacitive type and the like may be used. The touch panel 11 may have a rectangular shape or a round periphery. The touch panel 11 is mounted with a flexible substrate 11a configured to transmit a signal, and is connected to a touch panel controller circuit board (not shown) arranged on a backside of the display device 101. A substrate of the touch panel 11 may be formed of a resin film, glass and the like.

<Protection Plate>

The protection plate 8 is arranged on the front surface so as to protect the display device 101. The protection plate 8 may have a rectangular shape or a round periphery. Also, the protection plate 8 may be planar or may be curved in a thickness direction. A black frame printing may be performed for the protection plate 8 so as to improve the design characteristic of the display device 101. Also, a paint material allowing the infrared ray to partially penetrate therethrough is used in the black fame printing region (which will be described in detail later). Also, low reflection processing and low glare processing may be performed for a surface of the protection plate 8, as required. Also, a transfer of a fingerprint to the surface thereof may be suppressed. The protection plate 8 may be formed of a resin film, glass and the like. For the resin material, hard coat processing may be performed, and for the glass, a variety of hardening processing may be performed. It is possible to appropriately freely select the materials, the type of the hardening, the type of the printing, the type of the surface treatment and whether or not to perform the surface treatment.

<Infrared Sensor Unit>

The proximity sensor (the infrared sensor unit 9) is configured by the infrared sensor 10a, the light guide plate 10 for an infrared sensor configured to guide the light to the infrared sensor 10a and a circuit board (not shown) configured to drive the infrared sensor 10a. The infrared sensor 10a is arranged so that a light emission part thereof faces a side surface of the light guide plate 10 for an infrared sensor, and emits an infrared light so that it is incident on the light guide plate 10 for an infrared sensor. The light emitted from the infrared sensor 10a is emitted to a light emission surface 10b via the light guide plate 10 for an infrared sensor. The light reflected on an external target of the electric device 102 is again guided to the infrared sensor 10a via the light guide plate 10 for an infrared sensor. Therefore, when a hand of a person is approached to the front surface of the display device 101, for example, the proximity sensor (the infrared sensor unit 9) arranged at the outside of the display device 101 detects the approaching and transmits a signal to a control system to chang a content to be displayed on the display device 101. Like this operation, the infrared sensor unit 9 has a feedback function of detecting a surrounding situation to determine an effect influencing an image signal to be input to the display device 101.

<Infrared Sensor>

The infrared sensor 10a includes a light emitting element configured to emit an infrared light and a light receiving element configured to receive the infrared light. The elements are accommodated in one package. Although the infrared sensor 10a includes the light emitting element and the light receiving element, the elements may be separate packages. A type of the infrared sensor 10a can be appropriately freely selected. Also, the infrared sensor 10a is mounted on the same substrate as a point light source, which is used for the planar light source device 100, so that it is possible to reduce the number of members of the electric device. Also, the rear frame 2 extends to the position at which the infrared sensor 10a is arranged, so that it is possible to suppress the heat generation of the infrared sensor 10a.

<Light Guide Plate for Infrared Sensor>

The light guide plate 10 for an infrared sensor is used to guide the light to the infrared sensor 10a, and is made of a resin material, for example, a transparent acryl resin and a polycarbonate resin. The light guide plate 10 for an infrared sensor is arranged at a holding part 7b (which will be described later) provided for the intermediate frame 7 of the planar light source device 100.

<Rear Frame>

The rear frame 2 has the opening 2a. The light guide plate 1, the reflective sheet 5, the optical sheet group 4 and the light source (not shown) configured to emit the light are arranged therein. If a point light source is used as the light source, when the rear frame 2 is made of a metal material such as aluminum, it is possible to further improve the radiation performance of the point light source and to suppress the light loss, thereby improving the light utilizing efficiency of the planar light source device 100. In this illustrative embodiment, the rear frame 2 is made of the metal material.

<Intermediate Frame>

The intermediate frame 7 is provided with the holding part at a position facing a peripheral edge part of the display element 3 to hold and position the display element 3, and is engaged with the rear frame 2 to configure the display device 101. Also, as shown in FIG. 3, the intermediate frame 7 is formed with an extension part 7c extending outwardly from the display device 101, and the extension part 7c is provided with the holding part 7b to hold the infrared sensor unit 9. Also, the protection plate 8 is arranged on an upper surface of the extension part 7c (the holding part 7b), and a protrusion part 7a protruding from the upper surface of the extension part 7c and facing a side surface 8a of the protection plate 8 is provided to cover the periphery of the protection plate 8. By this structure, the intermediate frame 7 is engaged with the rear frame 2 configured to hold the light guide plate 1, the reflective sheet 5 and the optical sheet group 4 configuring the planar light source device 100, holds the display element 3 with facing the planar light source device 100, configures the display device 101, and holds the infrared sensor unit 9 at the holding part 7b formed at the extension part 7c extending outwardly from the display device 101. Also, since the intermediate frame 7 is configured to hold the protection plate 8 by the protrusion part 7a provided at the extension part 7c, the intermediate frame 7 holds the infrared sensor unit 9 and the protection plate 8 with one member.

In the meantime, a clearance between the protrusion part 7a of the intermediate frame 7 and the side surface 8a of the protection plate 8 can be adjusted as regards the size thereof, depending on the size of the display device 101 and the materials and shapes of the intermediate frame 7 and the protection plate 8. The material of the intermediate frame 7 can be appropriately freely selected, depending on the shape and size of the intermediate frame 7, the clearance between the intermediate frame 7 and the protection plate 8, and the like. For example, the resin material such as polycarbonate is used. Also, in the display device 101 of this disclosure, the touch panel 11 is provided on the front surface of the display element 3, and the protection plate 8 is arranged thereon.

In the intermediate frame 7, the infrared sensor unit 9 may be held by an elastic force when the holding part 7b is formed by a spring structure, for example.

In the below, operations of the electric device 102 of this disclosure are described. It is shown in FIG. 3 that the intermediate frame 7 is configured to arrange the protection plate 8 at the holding part 7b formed at the extension part 7c extending outwardly from the display device 101. The infrared sensor 10a (the infrared light emitting/receiving elements) of the proximity sensor unit (the infrared sensor unit 9) arranged at the outside of the display device 101 is configured to detect a surrounding situation of the display device 101 by the infrared light and to transmit a signal to the control system to change a content to be displayed on the display device 101. Thereby, it is possible to hold the display device 101 and the member configuring the infrared sensor unit 9 by the integrally formed (common) intermediate frame 7. Therefore, it is not necessary to provide the display device 101 with a separate member for holding and connecting the infrared sensor unit 9, so that it is possible to suppress the increase in the number of components configuring the electric device 102 having the display device 101.

As described above, according to the electric device 102 of this disclosure, the intermediate frame 7 configured to hold the display device 101 is formed with the extension part 7c extending outwardly from the display device 101, and the holding part 7b configured to hold the infrared sensor unit 9 is formed integrally with the extension part 7c. Therefore, when the infrared sensor unit 9 is arranged at the periphery of the display device 101, since it is not necessary to arrange a separate member such as a holding member of the infrared sensor unit 9 and a coupling member for coupling the holding member and the display device, it is possible to suppress the increase in the number of components of the electric device 102.

Also, the intermediate frame 7 is integrally formed and the infrared sensor unit 9 is held at the holding part 7b formed at the extension part 7c. Therefore, since it is not necessary to set an arrangement of the coupling member and the clearance between the coupling member and the intermediate frame 7, it is possible to suppress the increase in the external size of the electric device 102.

Further, as shown in FIGS. 3 to 5, the intermediate frame 7 is formed with the protrusion part 7a configured to cover the side surface 8a of the protection plate 8 when arranging the protection plate 8 on the front surface of the display element 3. Thereby, a cumulative tolerance of a size tolerance and an erection tolerance of each member, which is required when a member to which the protection plate 8 is fixed and a member having the protrusion part 7a are separately provided, is not necessary. Therefore, it is possible to reduce the clearance between the protection plate 8 and the intermediate frame 7 configuring the display device 101, thereby improving the design characteristic. That is, if the electric device 102 is configured so that the separate members are arranged at the display device 101 to cover the side surface 8a of the protection plate 8, a clearance is required between the protection plate 8 and the sidewall of the electric device 102 having the display device 101 so as to suppress the influences of a size precision and an assembling precision of a processed product. However, according to this disclosure, since the integral component is provided, it is possible to reduce the clearance, so that the above problems can be solved.

Also, the side surface 8a of the protection plate 8 is covered by the protrusion part 7a formed at the extension part 7c of the intermediate frame 7, which contributes to the improvement on the design characteristic of the electric device 102 having the display device 101.

Further, if the infrared sensor unit 9 is held by a separate member, it takes predetermined time to assemble the display device 101 and the infrared sensor unit 9 in an attaching process. However, according to this disclosure, since it is not necessary to assemble the display device 101 and the infrared sensor unit 9, it is possible to shorten the time required to assemble the display device 101 and the infrared sensor unit 9 and the process time. As a result, it is possible to provide the display device at low cost.

Also, in the display device 101 of this illustrative embodiment, a color of the intermediate frame 7 is not particularly limited. In order to suppress light leakage through a gap between the intermediate frame 7 and the display element 3, the black intermediate frame 7 is provided. Although a color of the surface of the protrusion part 7a of the intermediate frame 7 is generally black or white, as described above, it can be appropriately freely selected in conformity to the design of the electric device 102 having the display device 101. For example, when the black protrusion part is provided in conformity to a black frame printed on the protection plate 8, it is possible to accomplish a design by which the protection plate 8 and the surrounding case are seen to be integral. Also, when the electric device 102 having the display device 101 is blue, for example, the surface of the protrusion part 7a of the intermediate frame 7 is painted to blue and the parts facing the reflective sheet, the light guide plate 1 and the optical sheet group 4 are painted to white, so that it is possible to secure compatibility between the design characteristic and the efficiency improvement of the planar light source device 100.

In the meantime, the protrusion part 7a of the intermediate frame 7 may be provided at the entire periphery of the protection plate 8. However, the protrusion part may cover a part of the side surface 8a of the protection plate 8 and may cover a part of the surface of the protection plate 8 as well as the side surface 8a of the protection plate 8.

Also, only a part of the infrared sensor unit 9 may be held by the intermediate frame 7. For example, the light guide plate 10 for an infrared sensor may be held by the intermediate frame 7 and the infrared light receiving/emitting elements may be provided at the outside.

Also, as shown in FIG. 3, when seen from a plan view, the infrared sensor unit 9 may be arranged at any position of the upper, lower, left and right sides of the electric device 102 on the basis of the paper sheet, may be arranged at one side and may be arranged in a pair. The arrangement thereof can be appropriately freely selected.

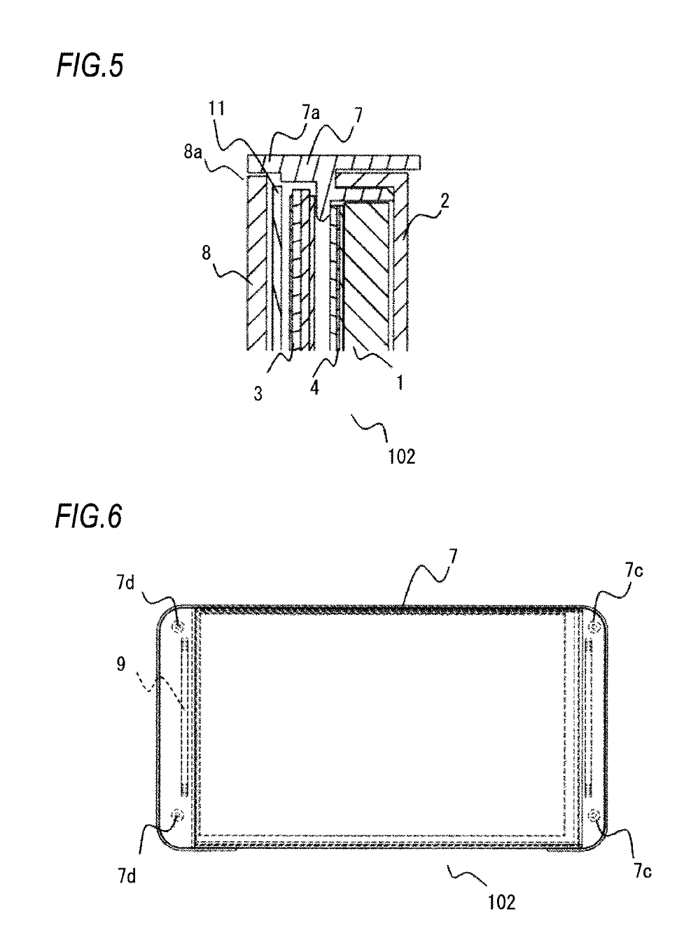

FIG. 6 is a rear view of the electric device 102 of this illustrative embodiment. As shown in FIG. 6, a fixing part 7d for fixing the display device 101 is integrally provided on a backside of the intermediate frame 7. By using the fixing part 7d, it is possible to attach the display device 101 to an external housing (not shown) and the like.

### Second Illustrative Embodiment

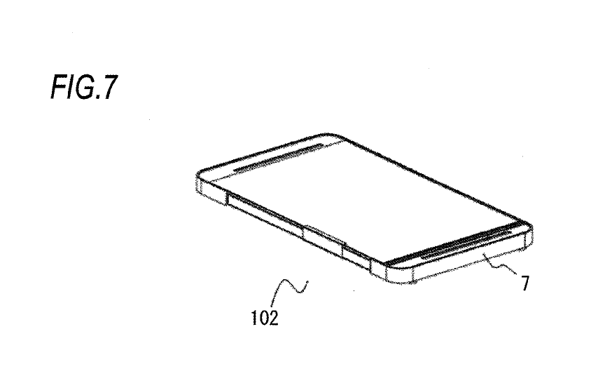

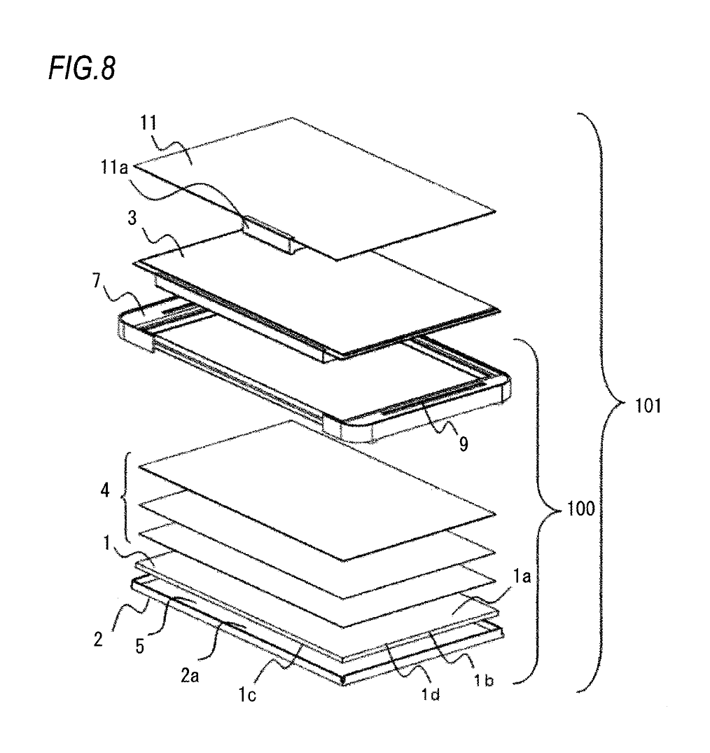

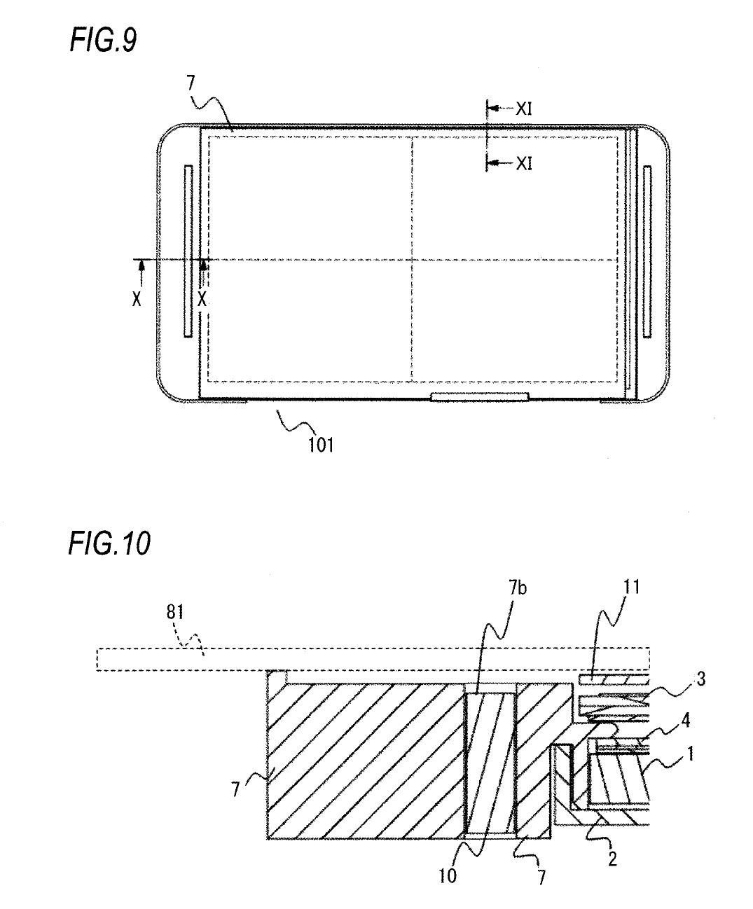

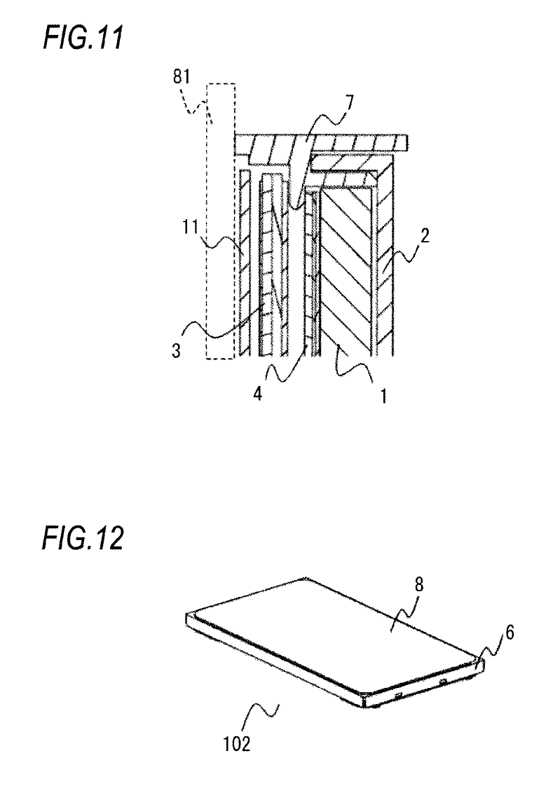

FIG. 7 is a perspective view of the electric device 102 according to a second illustrative embodiment, FIG. 8 is an exploded perspective view of FIG. 7, FIG. 9 is a front view of the electric device 102 of the second illustrative embodiment, FIG. 10 is a sectional view taken along a line X-X of FIG. 9 and FIG. 11 is a sectional view taken along a line XI-XI of FIG. 9.

In the electric device 102 of the first illustrative embodiment, the protrusion part 7a of the intermediate frame 7 is configured to cover the side surface 8a of the protection plate 8 when arranging the protection plate 8 on the front surface of the display element 3. In contrast, in the second illustrative embodiment, as shown in FIG. 10 or 11, the electric device 102 is attached on its front surface with a housing 81 (shown with the dotted line) having a function of the protection plate 8 configured to protect the display element 3. Since the housing 81 having an integrated protection plate is attached to the electric device 102, it is possible to obtain the seamless electric device 102.

<Housing>

In the second illustrative embodiment, the electric device 102 is held at the housing 81 having the function of the protection plate 8 and the housing is attached to the display surface-side. The housing is made of a resin material such as ABS (acrylonitrile butadiene styrene).

### Third Illustrative Embodiment

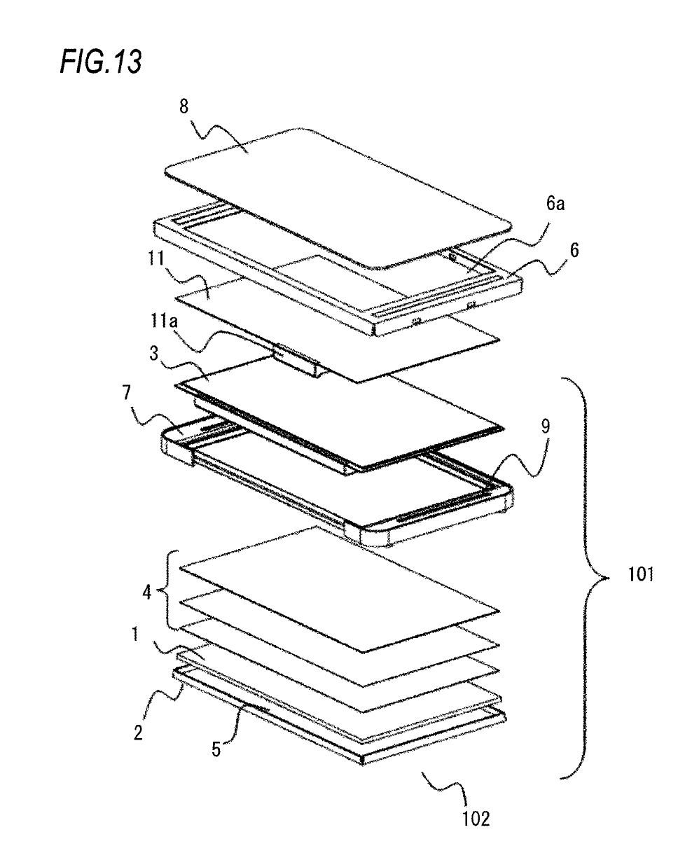

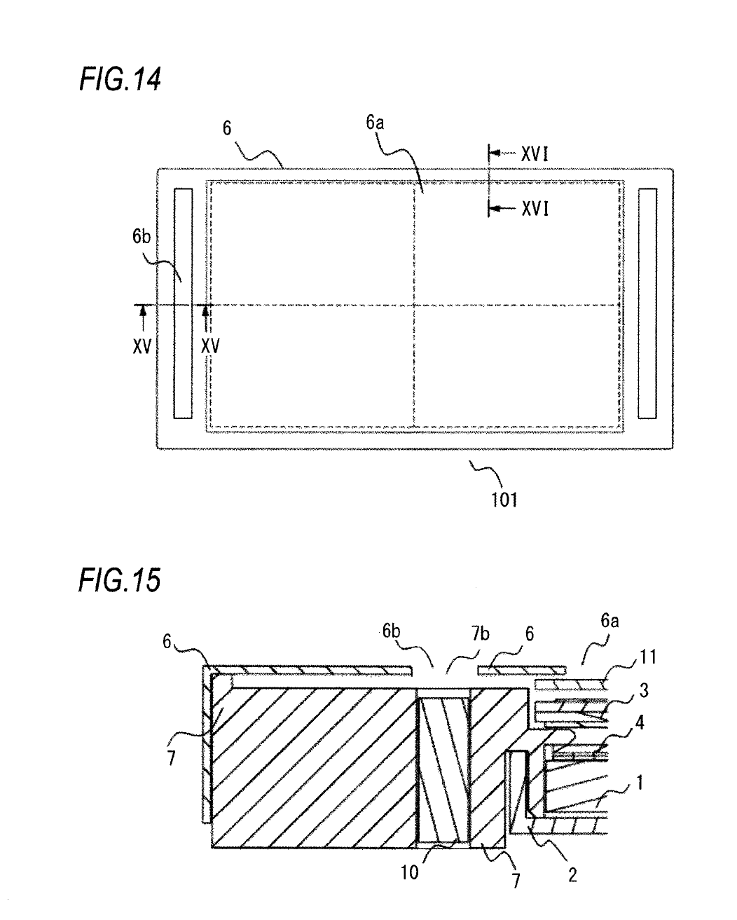

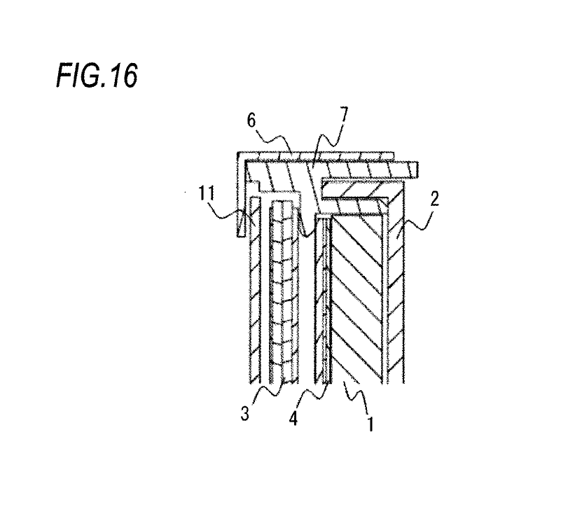

FIG. 12 is a perspective view of the electric device according to a third illustrative embodiment, FIG. 13 is an exploded perspective view of FIG. 12, FIG. 14 is a front view of the electric device 102 of the third illustrative embodiment, FIG. 15 is a sectional view taken along a line XV-XV of FIG. 14 and FIG. 16 is a sectional view taken along a line XVI-XVI of FIG. 14.

In FIG. 12, the electric device 102 of the third illustrative embodiment is provided on the front surface of the display element 3 with a front frame 6. The front frame 6 is fitted with the intermediate frame 7 to hold the display element 3 and/or touch panel 11. As shown in FIG. 13, the protection plate 8 may be arranged on a front surface of the front frame 6. The protection plate 8 is optically adhered to the display element 3 through the front frame 6 or the periphery of the protection plate 8 is adhered to a trim part of the front frame 6.

<Front Frame>

The front frame 6 has an opening 6a for exposing the display surface of the display element 3. Also, an opening 6b for exposing the infrared sensor unit 9 is provided at the position, at which the infrared sensor unit 9 held by the intermediate frame 7 is arranged, so as not to obstruct the function of the infrared sensor unit 9. In the meantime, the opening 6b may be a notch.

The front frame 6 is made of a metal material such as aluminum or a material including the metal material, so that it is possible to improve the stiffness (strength) of the electric device 102.

Also, the front frame 6 may be made of a resin material and may configure a part of the housing of the electric device 102.

Also, a surface of the front frame 6, which is arranged on the display surface-side, may be colored to improve the design characteristic of the electric device 102.

In addition, this disclosure is not limited to the above illustrative embodiments and a variety of changes and combinations can be made without departing from the scope of this disclosure. The member held at the intermediate frame 7 is not limited to the infrared sensor unit and may be a component for adding a function to the display device provided for the electric device 102, for example, a light emitting diode for decoration. Also, the types, arrangement positions and the like of the light source and the light guide plate can be appropriately selected.

What is claimed is:

1. An electric device comprising:
a display device comprising:
a display element configured to display an image;
a light source;
an intermediate frame configured to hold the light source; and
a planar light source device configured to illuminate the display element, and
a proximity sensor arranged at an outside of the display device and configured to detect approaching information to the display device,
wherein the intermediate frame is provided with an extension part extending outwardly from the display device and a holding part configured to integrally hold the proximity sensor is formed at the extension part.

2. The electric device according to claim 1,
wherein the proximity sensor comprises:
a light emitting element configured to emit an infrared light, and
a light guide plate having an incident surface facing a light emission surface of the light emitting element and configured to penetrate the infrared light emitted from the light emitting element therethrough.

3. The electric device according to claim 1,
wherein the display device includes a control system that has feedback function of receiving the information detected by the proximity sensor and controls an image to be displayed on the display element.

4. The electric device according to claim 1, further comprising:
a protection plate arranged to face a display surface of the display element and configured to protect the display element,
wherein the protection plate is held by the extension part of the intermediate frame.

5. The electric device according to claim 4,
wherein the intermediate frame is provided with a protrusion part protruding from the extension part, and
wherein the protrusion part is arranged to face a side surface of the protection plate.

6. The electric device according to claim 1, further comprising:
a front frame configured to be fitted with the intermediate frame to hold the display element and the planar light source device at a display surface-side of the display element; and
a protection plate configured to protect the display element at a display surface-side of the front frame.

7. The electric device according to claim 6,
wherein the front frame is formed with an opening or notch at a position at which the proximity sensor is arranged, so that the proximity sensor is exposed.

8. The electric device according to claim 6,
wherein the protection plate is optically adhered to the display element through the front frame.

9. The electric device according to claim 6,
wherein the protection plate is adhered to a trim part of the front frame.
